(19) United States
(12) Patent Application Publication
(10) Pub. No.: US 2025/0278459 A1
(43) Pub. Date: Sep. 4, 2025

(54) DOWNSTREAM PROCESSING OF EMBEDDING INFORMATION ITEMS

(71) Applicant: AUTOBRAINS TECHNOLOGIES LTD, Tel Aviv-Yafo (IL)

(72) Inventor: Tomer COHEN, Tel Aviv-Yafo (IL)

(73) Assignee: AUTOBRAINS TECHNOLOGIES LTD, Tel Aviv-Yafo (IL)

(21) Appl. No.: 18/593,948

(22) Filed: Mar. 3, 2024

(51) Int. Cl. G06F 18/20; G06F 18/2135

(52) U.S. Cl. CPC G06F 18/295; G06F 18/21355

(57) ABSTRACT

A method for downstream processing of embedding information items, the method includes (i) receiving multiple evaluated element embedding information items that represent multiple evaluated elements within an environment of a vehicle; (ii) identifying that the multiple evaluated element embedding information items are classified into an insufficient confidence level; and (iii) for each one of the multiple evaluated embedding information items identified as an being classified into the insufficient confidence level, automatically routing evaluated element information to a corresponding embedding information item-based classification unit that is trained to classify elements represented by the evaluated element embedding information item associated with the corresponding population of embedding information items.

### BACKGROUND

Assisted and autonomous driving systems are known in the art. In such systems, computer implemented systems control (at least to some extent) some, or all, of a vehicle's driving functions, e.g., speed, telemetry, braking, etc. The vehicle is typically equipped with one or more sensors to provide the system with current information regarding the driving environment. The current information for the driving environment is typically used by the driving system to determine how to drive on roadways.

One of the major tasks related to driving is classifying.

There is a growing need to provide efficient classification systems and methods.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1A illustrates an example of a system;

FIG. 1B illustrates an example of a system;

FIG. 1C illustrates an example of a system;

FIG. 2 illustrates an example of clusters, scores and embeddings;

FIG. 3 is an example of a method;

FIG. 4 is an example of a method;

FIG. 5 illustrates an example of a system;

FIG. 6 is an example of a method;

FIG. 7 is an example of an image and various information elements;

FIG. 8 is an example of an image, keypoints and a cropped image;

FIG. 9 is an example of an image, a cropped image and various information elements;

FIG. 10 is an example of a method;

FIG. 11 is an example of images and a cropped images;

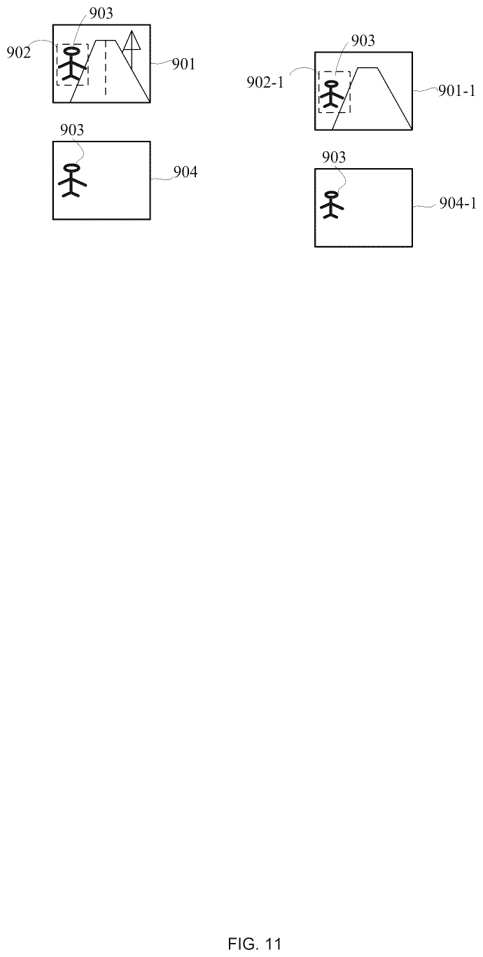

FIG. 12 is an example of an image, cropped images, a first neural network, various units and various information elements; and

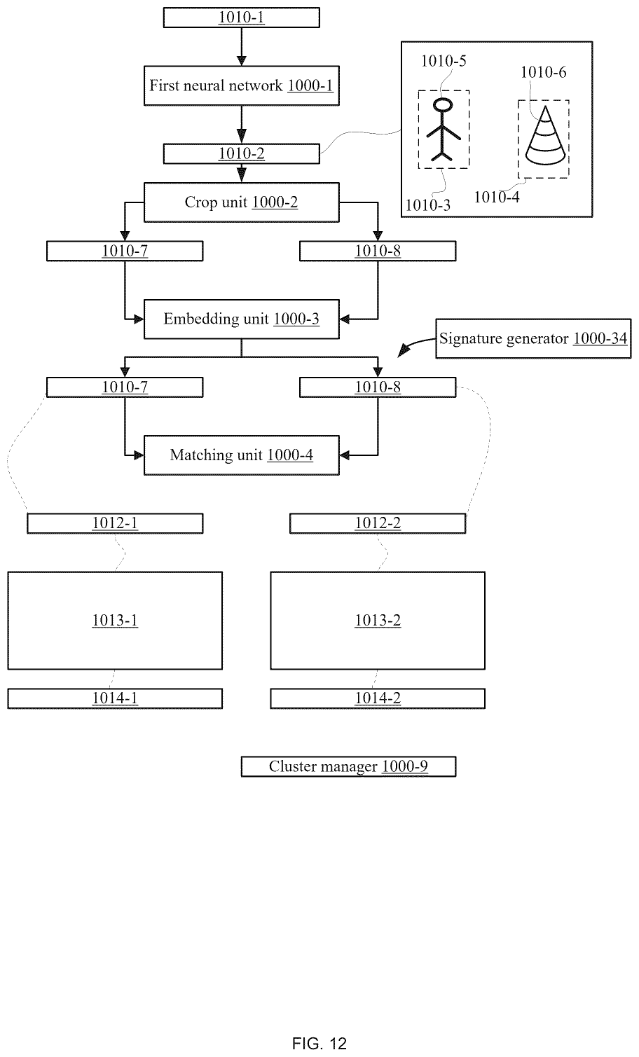

FIG. 13 is an example of a method.

### DETAILED DESCRIPTION

There is provided a method, a system and a computer readable medium that are adaptable and are configured to adjust to dynamically received information and solve classification errors by using multiple embedding-based classification units-some of which are tailored to classify elements that were not classified by other embedding-based classification units.

An embedding information item may be an embedding or a signature of an embedding.

For simplicity of explanation, some of the examples refer to embeddings. Any reference to an embedding should be applied, mutatis mutandis to any other embedding information item-such as but not limited to a signature of the embedding.

According to an embodiment, there is provided a method, a system and a non-transitory computer readable medium for downstream processing of embeddings that are identified to be classified into an insufficient confidence level.

The embedding represents an element selected of an object or a road scenario. The element was captured by a sensed information unit. The embedding may be generated based on a cropped sensed information unit. An embedding that is defined as being classified into an insufficient confidence level indicates that the element is not properly classified by the embedding-based classification unit.

According to an embodiment, the identification of an embedding as being classified into an insufficient confidence level triggers downstream processing of the embedding-by another embedding-based classification unit-for classifying the element represented by the embedding. The other embedding-based classification unit better fits (for example better trained or be tailored for) to classify the element.

According to an embodiment, there are multiple other embedding-based classification units that are trained (or otherwise configured) to successfully classify an element that was classified into an insufficient confidence level.

According to an embodiment the embedding-based classification units are arranged in a hierarchical layer. According to an embodiment-an embedding-based classification unit of a higher level of the hierarchy is trained across a broader population of embeddings than an embedding-based classification unit of a lower level of the hierarchy.

According to an embodiment, there are provided routing rules that route the sensed information unit associated with the embedding being classified into an insufficient confidence level to a corresponding other embedding-based classification unit that is trained (or otherwise configured) to successfully classify the object.

The different figures illustrates examples of units and/or software and/or information items and/or steps and/or components. These examples are provided for brevity of explanation. At least one of the units and/or software and/or information items and/or steps and/or components is optional or mandatory.

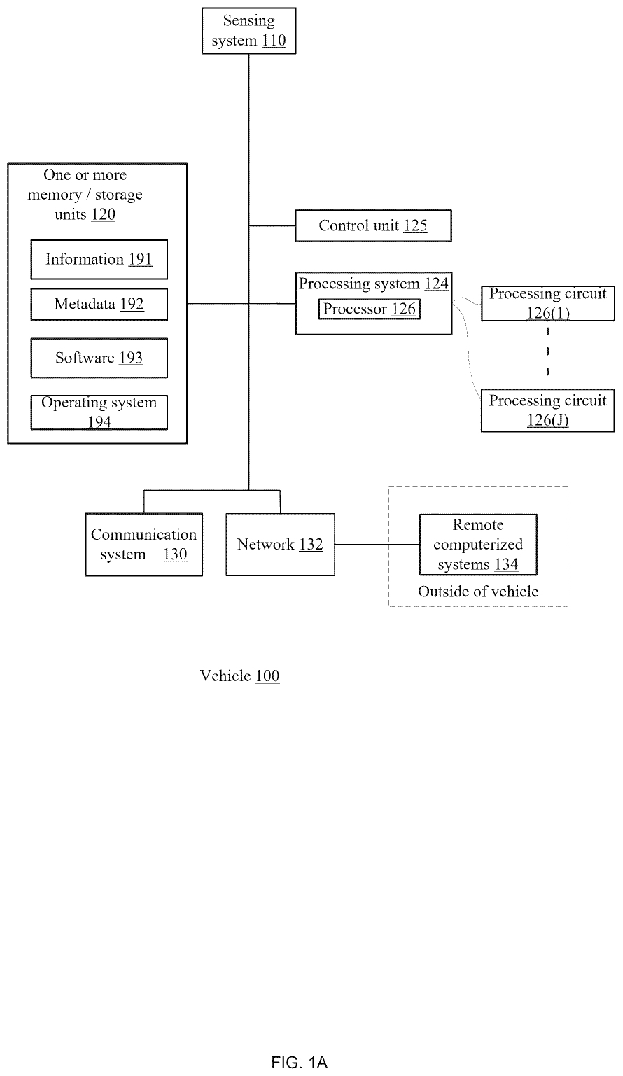

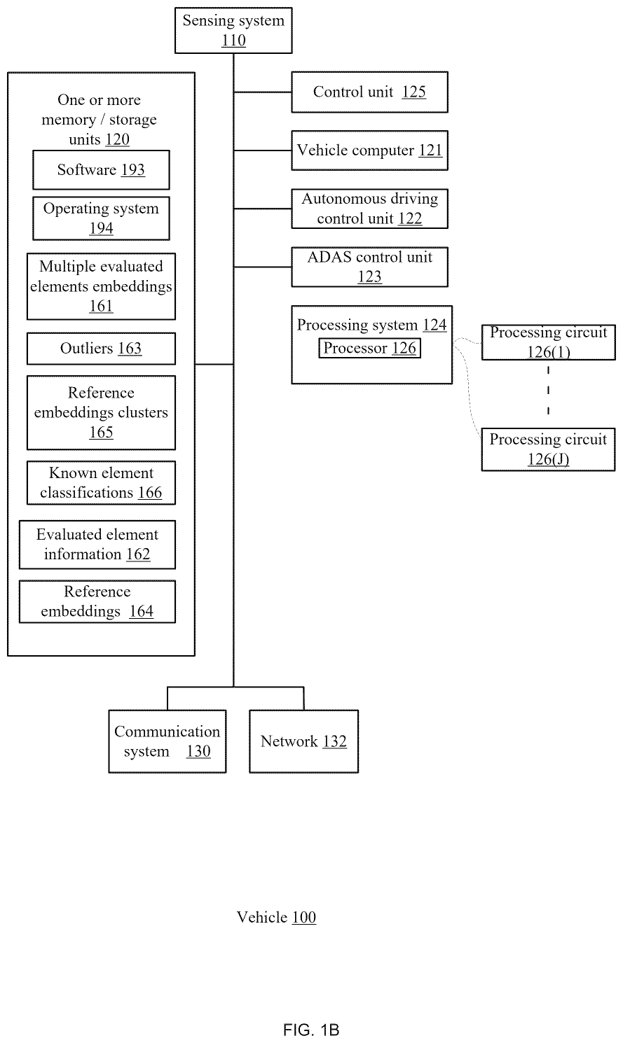

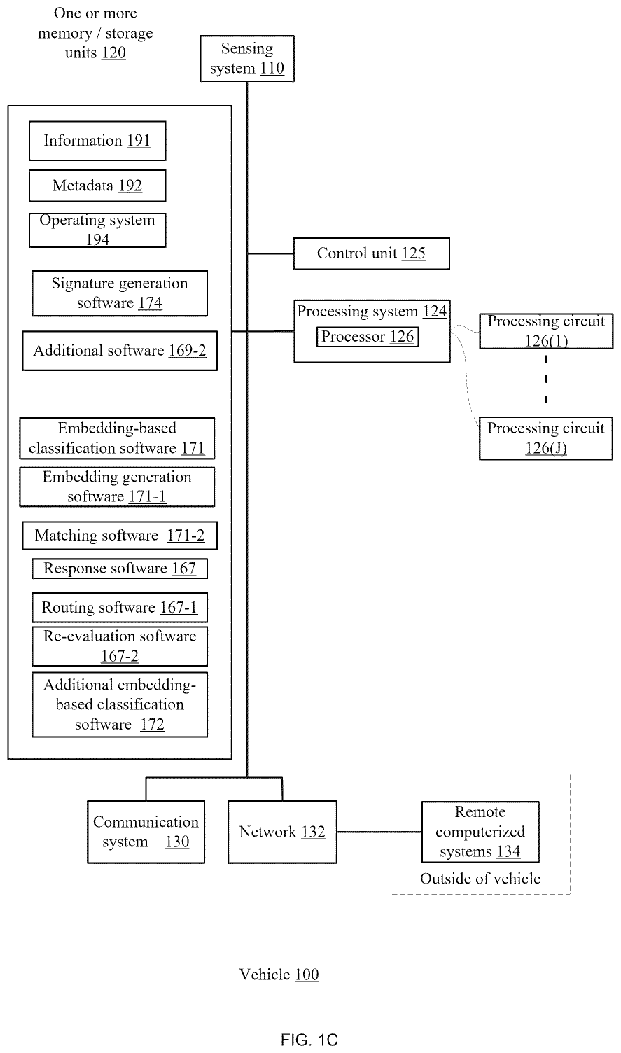

FIG. 1A illustrates an example of a vehicle 100, a network 123 and remote computerized systems 134.

The vehicle 100 includes (a) sensing system 110, a communication system 130, one or more memory and/or storage units 120, and additional units that include control unit 125, advanced driver assistance system (ADAS) control unit 123, autonomous driving control unit 122, processing system 124 including processor 126. Network 123 is in communication with the vehicle and with the remote computerized systems 134 such as servers, cloud computers, and the like.

Communication system 130, one or more memory and/or storage units 120, and processing system 134 may form a computerized system. The computerized system may include one or more other systems and/or units such as sensing system 110

The communication system 130 is configured to enable communication between the one or more memory and/or storage units 120 and/or the sensing system 110 and/or any one of the additional units and/or the network 132 (that is in communication with the remote computerized systems).

The control unit 125 is configured to control various operations related to the vehicle-such as but not limited to various steps of method 200 and/or of method 201.

The one or more memory and/or storage units 120 are illustrated as storing an operating system 194, software 193 (especially software required to execute method 200 and/or of method 201), information 191 and metadata 192 (especially information and metadata required to execute method 200 and/or of method 201). The information may include environmental information. The metadata may include any metric or an outcome of processed information-especially related to the execution of method 200 and/or of method 201.

FIG. 1B and FIG. 1C differ from FIG. 1A by including additional units such as ADAS control unit 123, autonomous driving control unit 123, and vehicle computer 123.

FIG. 1B and FIG. 1C differ from FIG. 1A by including more examples of content stored in the one or more memory and/or storage units 120.

The sensing system 110 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 110 is configured to output one or more sensed information units (SIUs).

The communication system 130 is configured to enable communication between the one or more memory and/or storage units 120 and/or the sensing system 110 and/or any one of the additional units and/or the network 132 (that is in communication with the remote computerized systems).

The controller 125 is configured to control the operation of the sensing system 110, and/or the one or more memory and/or storage units 120 and/or the one or more additional units (except the controller).

The ADAS control unit 123 is configured to control ADAS operations.

The autonomous driving control unit 122 is configured to control autonomous driving of the autonomous vehicle.

The vehicle computer 121 is configured to control the operation of the vehicle-especially controlling the engine, the transmission, and any other vehicle system or component.

The processing system 124 may include processor 146 and one or more other processors and is configured to execute any method illustrated in the specification.

The one or more memory and/or storage units 120 are configured to store firmware and/or software, one or more operating systems, data and metadata required to the execution of any of the methods mentioned in this application.

FIGS. 1B and/or FIG. 1C illustrates the one or more memory and/or storage units 120 as storing at least some of:
a. Multiple evaluated elements embeddings 161.
b. Evaluated element information 162 such as sensed information units (for example-cropped or not cropped sensed information units).
c. Outliers 163.
d. Reference embeddings 164.
e. Reference embeddings clusters 165.
f. Known element classifications 166.
g. Response software 167 that may include routing software 167-1, a re-evaluation software 167-2 for re-evaluating the plurality of reference embeddings.
h. Embedding-based classification software 171. The embedding-based classification software may include embedding generation software 171-1 and a matching software 171-2 configured to match an evaluated element embedding to the reference embeddings.
i. Additional embedding-based classification software 172.
j. Routing rules 168.
k. Signature generation software 174 configured to generate a signature. The signature may be a signature of an embedding. The signature may be generated based on the SIU but may be generated based on other information. Examples of a signature and signature generators that are examples of detectors are illustrated in U.S. patent application Ser. No. 17/309,064 publication serial number 2022/0041184 which is incorporated herein by reference.
l. Operating system 169-1.
m. Additional software 169-2 that may be used to perform any other functionality of the vehicle and/or of any of the other units illustrated in FIG. 1.

The vehicle computer 121 may be in communication with an engine control module, a transmission control module, a powertrain control module, and the like

The memory and/or storage units 120 was shown as storing software. Any reference to software should be applied mutatis mutandis to code and/or firmware and/or instructions and/or commands, and the like.

Processor 126 includes a plurality of processing units 126(1)-126(J), J is an integer that exceeds one. Any reference to one unit or item should be applied mutatis mutandis to multiple units or items. For example-any reference to processor should be applied mutatis mutandis to multiple processors, any reference to communication system 130 should be applied mutatis mutandis to multiple communication systems.

According to an embodiment, the one or more memory and/or storage units 120 includes one or more memory unit, each memory unit may include one or more memory banks.

According to an embodiment, the one or more memory and/or storage units 120 includes a volatile memory and/or a non-volatile memory. The one or more memory and/or storage units 120 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art-such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 130. Other communication elements may be provided.

FIG. 1 illustrates communication system 130 as being in communication with various processors and/or units and network 132.

The communication system 130 may include a bus. The represents one or more of several possible types of bus structures, including a memory bus or memory controller, a peripheral bus, an accelerated graphics port, and a processor or local bus using any of a variety of bus architectures. By way of example, such architectures can comprise an Industry Standard

Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 132 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 130) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 120 may be stored outside the vehicle. It should also be noted that the processor may evaluate signatures generated by a plurality of detectors.

According to an embodiment-an evaluated element embedding information item may be classified with a confidence level. The confidence level may be binary (outlier or inlier) or non-binary—for example may be a percent; or score; or any level within a specified range; or any level out of two or more levels. The confidence level may be calculated in various manners—such as based on a distance between the evaluated element embedding information to a reference point-such as a centroid of a cluster—or any other reference point—such as a reference point located within (or without) the cluster.

Any reference to an embedding information item that is classified into an insufficient confidence level should be applied mutatis mutandis to an outlier.

According to an embodiment, what amount to insufficient confidence level is defined in one or more manners and/or by one or more entities (such as a user, a driver, a manufacturer, an insurance company, a vendor, and the like). For example—an inlier may be associated with an insufficient confidence level if he is located at least a defined distance away from the centroid and/or if is among a defined percent of the most distant inliers from the centroid, and the like. If, for example the level of confidence level ranges between 1 to 100 then what amount to insufficient may be lower than any number-for example lower than 5, 10, 15, 20, 25, 30, 35, 40, 45, 50, 55, 60, 65, 70, 75, 80, 85, 90, 95, 98, 99 and the like. According to an embodiment, the processor is configured to:
a. Receive multiple evaluated elements embeddings that represent multiple evaluated elements within an environment of a vehicle. An evaluated element embedding is generated based on evaluated element information such as a sensed information unit or a cropped sensed information unit.
b. Evaluate whether the multiple evaluated elements embeddings are classified into an insufficient confidence level. According to an embodiment, the evaluation includes comparing each evaluated element embedding (of the multiple evaluated elements embeddings) to a plurality of reference embeddings. The plurality of reference embeddings represents a plurality of reference embeddings clusters. The plurality of reference embeddings clusters is associated with a plurality of known element classifications. It should be noted that the processing circuit may also receive evaluated element embeddings that are inliers-that represent evaluated elements of known classes. In this case, step 220 may include or may be followed by successfully classifying the evaluated elements associated with the evaluated embeddings.
c. Responding to the identification.

According to an embodiment, the responding includes at least one of:
a. Automatically routing evaluated element information associated with each evaluated element embedding of the multiple evaluated element embeddings, to a corresponding embedding-based classification unit that is trained to classify evaluated elements represented by the evaluated element embedding. This may include selecting each corresponding embedding-based classification unit out of a plurality of embedding-based classification units.
b. Classify the evaluated element, by the corresponding embedding-based classification unit. According to an embodiment, the classifying triggers a determination of a driving related operation for a vehicle. The driving related operation is selected out of performing an autonomous driving operation, performing an advanced driver assistance system (ADAS) operation, and the like. According to an embodiment, the classifying triggers an execution of a driving related operation for a vehicle.
c. Trigging a generation of a routing rule for bypassing the classifying when receiving future evaluated element embeddings having a same value as the evaluated element embedding previously classified as being classified into an insufficient confidence level.
d. Triggering a re-evaluation of the plurality of reference embeddings.
e. Determine that there is no existing embedding-based classification unit configured to classify an evaluated element represented by an evaluated element embedding identified as being classified into an insufficient confidence level. This may trigger a generation of a new embedding-based classification unit.

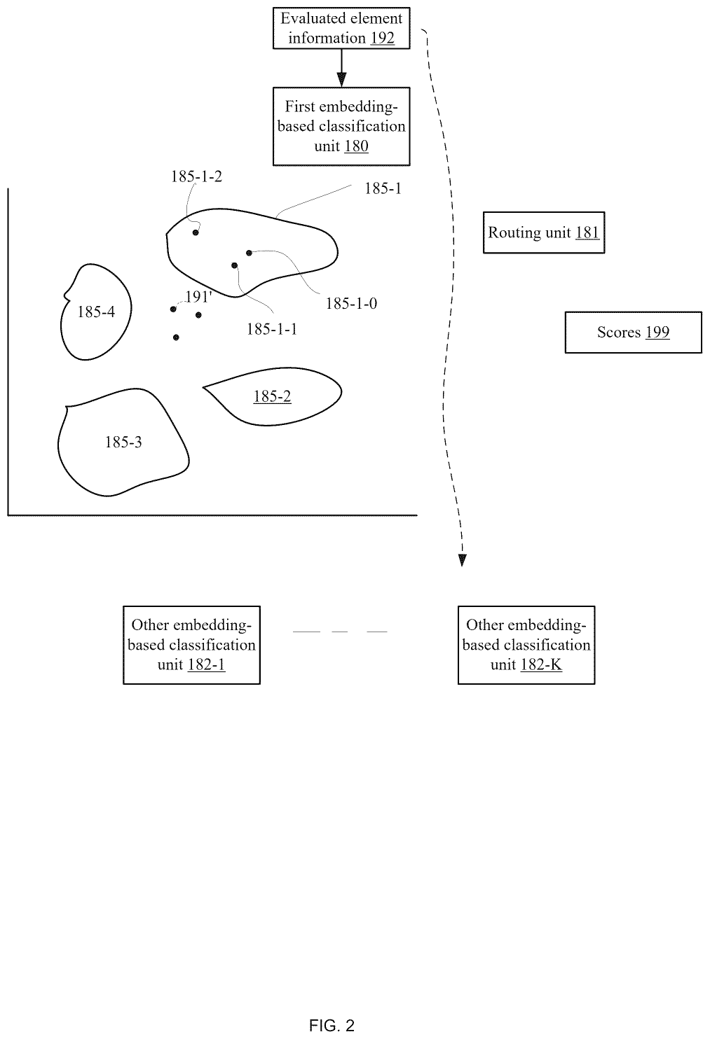

FIG. 2 illustrates an example of a first embedding-based classification unit 180, a routing unit 181, outliers 191′ and other embedding-based classification units 182-1 till 182-K.

Once an evaluated element embedding is found (by the first embedding-based classification unit 180) to be being classified into an insufficient confidence level, the routing unit 181 routs the evaluated element information 192 (associated with the evaluated element embedding 191) to one of the other embedding-based classification units 182-1 till 182-K.

The routing may be based on a similarity between the evaluated element embedding and embeddings that represent the other embedding-based classification units 182-1 till 182-K.

FIG. 2 also illustrates refence embedding clusters 185-1 till 185-5. Referring to FIG. 2—cluster 185-1 includes centroid 185-1-0 and various inliers such as 185-1-1 and 185-1-2 (and may also include other inliers that are not shown).

According to an embodiment, inlier 185-1-1 is closer to the centroid 185-1-0 in relation to inlier 185-1-2-and may be associated with a higher confidence level. Scores 199 of FIG. 2 are example of the confidence levels of various inliers.

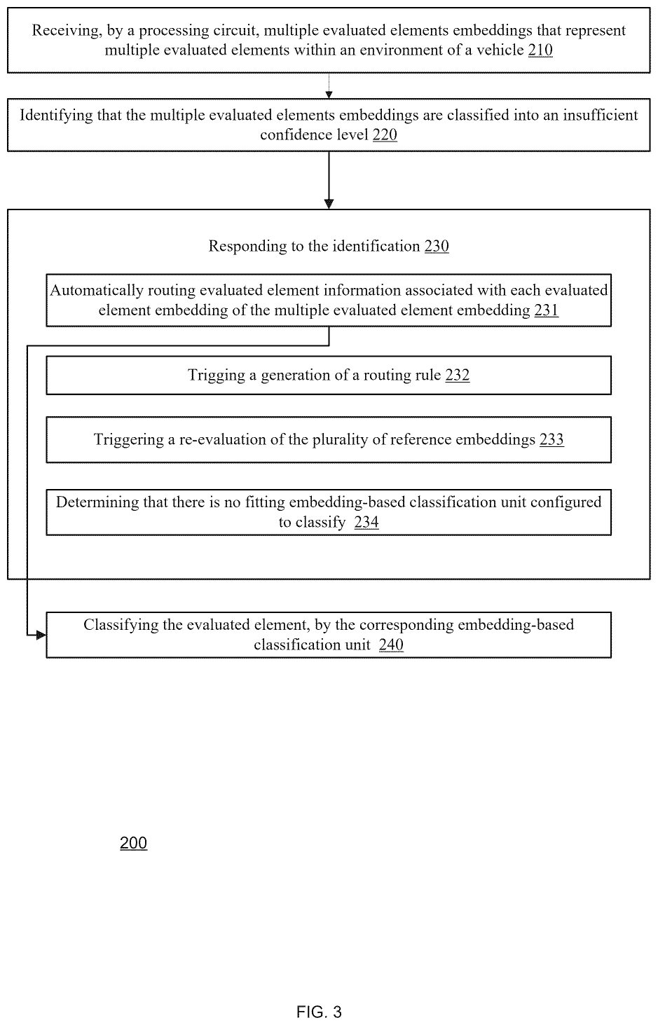

FIG. 3 illustrates an example of method 200 downstream processing of embedding information items.

According to an embodiment, method 200 includes step 210 of receiving, by a processing circuit, multiple evaluated elements embeddings that represent multiple evaluated elements within an environment of a vehicle. An evaluated element embedding is generated based on evaluated element information such as a sensed information unit or a cropped sensed information unit.

According to an embodiment, step 210 is followed by step 220 of identifying that the multiple evaluated elements embeddings classified into an insufficient confidence level. A population of embeddings includes one or more clusters of inliers and one or more outliers.

According to an embodiment, step 220 includes comparing each evaluated element embedding (of the multiple evaluated elements embeddings) to a plurality of reference embeddings. The plurality of reference embeddings represents a plurality of reference embeddings clusters. The plurality of reference embeddings clusters is associated with a plurality of known element classifications.

It should be noted that the processing circuit may also receive evaluated element embeddings that are inliers—that represent evaluated elements of known classes. In this case, step 220 may include or may be followed by successfully classifying the evaluated elements associated with the evaluated embeddings.

According to an embodiment, step 220 is followed by step 230 of responding to the identification.

According to an embodiment, step 230 includes step 231 of automatically routing evaluated element information associated with each evaluated element embedding of the multiple evaluated element embeddings, to a corresponding embedding-based classification unit that is trained to classify evaluated elements represented by the evaluated element embedding. These elements may belong to a population that includes the evaluated elements.

According to an embodiment, step 231 includes selecting each corresponding embedding-based classification unit out of a plurality of embedding-based classification units.

According to an embodiment, step 231 is followed by step 240 of classifying the evaluated element, by the corresponding embedding-based classification unit.

According to an embodiment, step 240 triggers a determination of a driving related operation for a vehicle. The driving related operation is selected out of performing an autonomous driving operation, performing an advanced driver assistance system (ADAS) operation, and the like.

According to an embodiment, step 240 triggers an execution of a driving related operation for a vehicle.

According to an embodiment, step 230 includes step 232 of trigging a generation of a routing rule for bypassing step 220 when receiving future evaluated element embeddings having a same value as the evaluated element embedding previously classified as being classified into an insufficient confidence level.

According to an embodiment, step 230 includes step 233 of triggering a re-evaluation of the plurality of reference embeddings.

According to an embodiment, step 230 includes step 234 of determining that there is no existing embedding-based classification unit configured to classify an evaluated element represented by an evaluated element embedding identified as being classified into an insufficient confidence level.

According to an embodiment, step 234 triggers a generation of a new embedding-based classification unit.

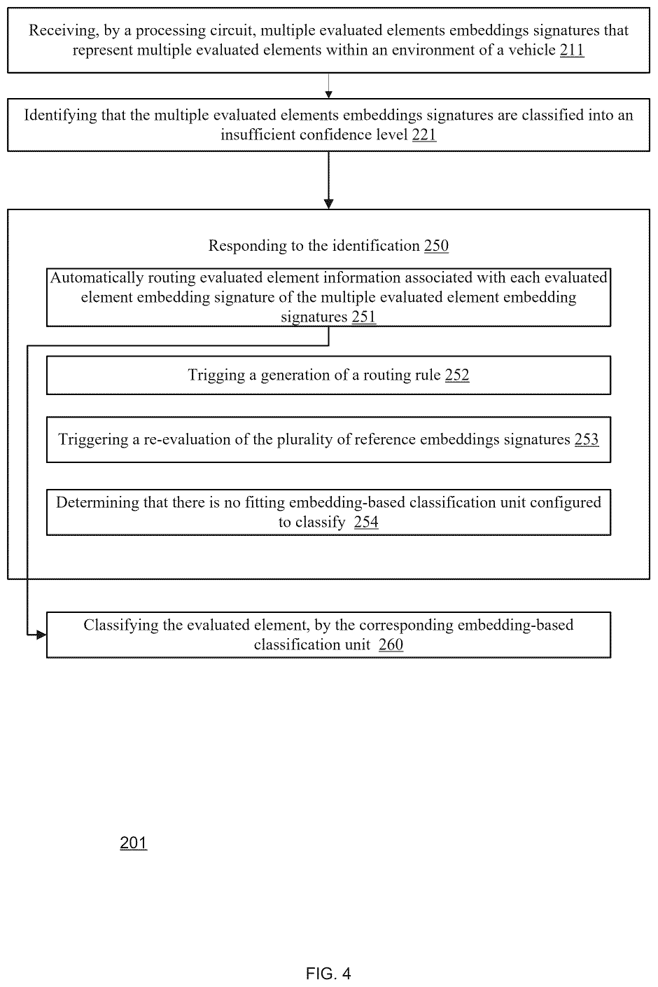

FIG. 4 illustrates an example of method 201 downstream processing of embedding signatures.

According to an embodiment, method 201 includes step 211 of receiving, by a processing circuit, multiple evaluated elements embeddings signatures that represent multiple evaluated elements within an environment of a vehicle. An evaluated element embedding signature is generated based on evaluated element information such as a sensed information unit or a cropped sensed information unit.

According to an embodiment, step 211 is followed by step 221 of identifying that the multiple evaluated elements embeddings signatures are classified into an insufficient confidence level.

According to an embodiment, step 221 includes comparing each evaluated element embedding signature (of the multiple evaluated elements embeddings signatures) to a plurality of reference embeddings signatures. The plurality of reference embeddings signatures represents a plurality of reference embeddings signatures clusters. The plurality of reference embeddings signatures clusters is associated with a plurality of known element classifications.

It should be noted that the processing circuit may also receive evaluated element embeddings signatures that are inliers-that represent evaluated elements of known classes. In this case, step 221 may include or may be followed by successfully classifying the evaluated elements associated with the evaluated embeddings signatures.

According to an embodiment, step 221 is followed by step 250 of responding to the identification.

According to an embodiment, step 250 includes step 251 of automatically routing evaluated element information associated with each evaluated element embedding signature of the multiple evaluated element embeddings signatures, to a corresponding embedding-based classification unit that is trained to classify evaluated elements represented by the evaluated element embedding.

According to an embodiment, step 250 includes selecting each corresponding embedding-based classification unit out of a plurality of embedding-based classification units.

According to an embodiment, step 250 is followed by step 260 of classifying the evaluated element, by the corresponding embedding-based classification unit.

According to an embodiment, step 250 triggers a determination of a driving related operation for a vehicle. The driving related operation is selected out of performing an autonomous driving operation, performing an advanced driver assistance system (ADAS) operation, and the like.

According to an embodiment, step 250 triggers an execution of a driving related operation for a vehicle.

According to an embodiment, step 251 includes step 252 of trigging a generation of a routing rule for bypassing step 221 when receiving future evaluated element embeddings signatures having a same value as the evaluated element embedding signature previously classified as being classified into an insufficient confidence level.

According to an embodiment, step 251 includes step 253 of triggering a re-evaluation of the plurality of reference embeddings signatures.

According to an embodiment, step 251 includes step 254 of determining that there is no existing embedding-based classification unit configured to classify an evaluated element represented by an evaluated element embedding signature identified as being classified into an insufficient confidence level.

According to an embodiment, step 254 triggers a generation of a new embedding—based classification unit.

### Examples of Embedding-Based Classification Units and Embedding-Based Classification Methods

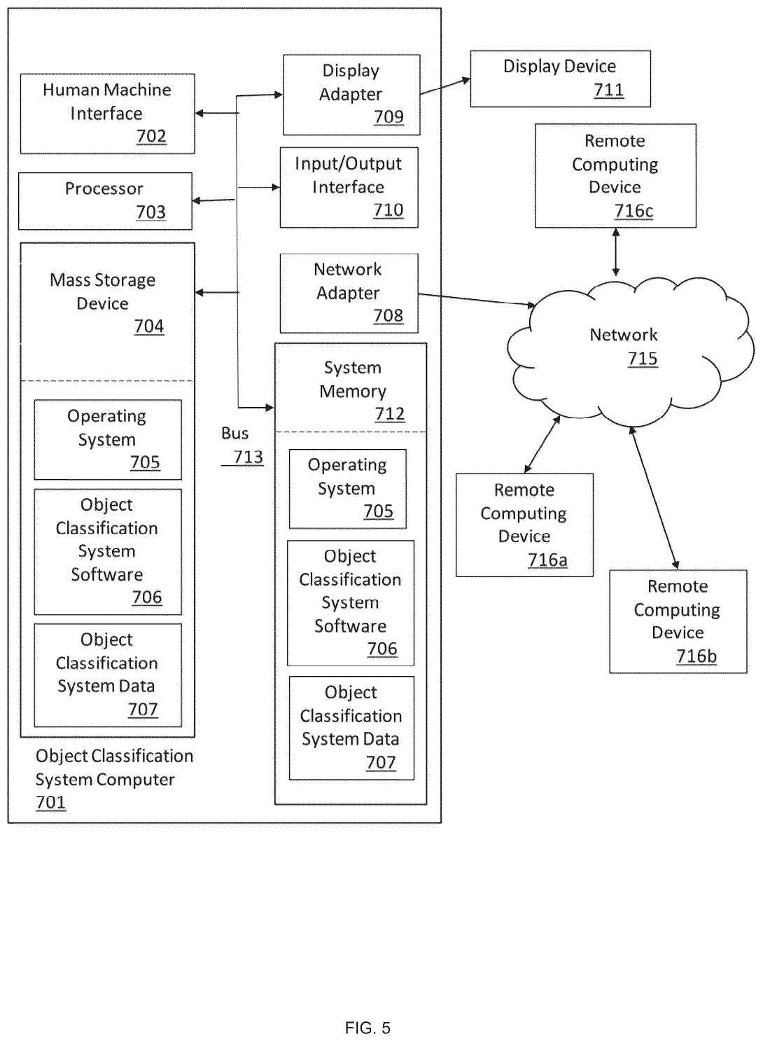

FIG. 5 is a block diagram illustrating an exemplary operating environment for performing at least a portion of disclosed methods according to an embodiment of the present invention. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

Further, one skilled in the art will appreciate that the systems and methods disclosed herein can utilize a specialized computing device in the form of an object classification system computer 701 (which may be included in, for example object classification system 100). The methods discussed above can be performed by the computer 701. For example, the computer 701 can perform the duties and responsibilities discussed above.

The components of the object classification system computer 701 can comprise, but are not limited to, one or more processors or processing units 703, a system memory 712, and a system bus 713 that couples various system components including the processor 703 to the system memory 712. In the case of multiple processing units 703, the system can utilize parallel computing.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, object classification system software 706, object classification system data 707, a network adapter 708, system memory 712, an Input/Output Interface 710, a display adapter 709, a display device 711, and a human machine interface 702, can be contained within one or more remote computing devices 714 a,b,c at physically separate locations, connected through buses of this form, in effect implementing a fully distributed system.

The object classification system computer 701 typically comprises a variety of computer readable media. Exemplary readable media can be any available media that is accessible by the object classification system computer 701 and comprises, for example and not meant to be limiting, both volatile and non-volatile media, removable and non-removable media. The system memory 712 comprises computer readable media in the form of volatile memory, such as random-access memory (RAM), and/or non-volatile memory, such as read only memory (ROM). The system memory 712 typically contains data such as object classification system data 707 and/or program modules such as operating system 705 and object classification system software 706 (i.e., modules and the like that perform the methods discussed above) that are immediately accessible to and/or are presently operated on by the processing unit 703.

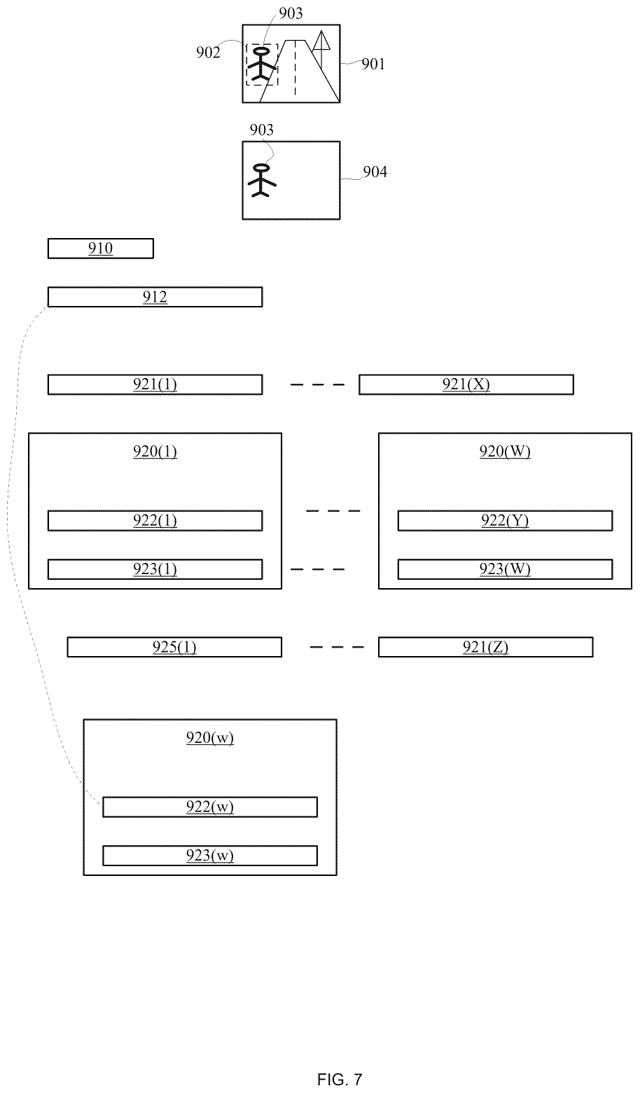

In another aspect, the object classification system computer 701 can also comprise other removable/non-removable, volatile/non-volatile computer storage media. By way of example, FIG. 7 illustrates a mass storage device 704, which can provide non-volatile storage of computer code, computer readable instructions, data structures, program modules, and other data for the object classification system computer 701. For example, and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and object classification system software 706. Each of the operating system 705 and object classification system software 706 (or some combination thereof) can comprise elements of the programming and the object classification system software 706. object classification system data 707 can also be stored on the mass storage device 704. object classification system data 707 can be stored in any of one or more databases known in the art. Examples of such databases include DB2®, Microsoft® Access, Microsoft® SQL Server, Oracle®, mySQL, PostgreSQL, and the like. The databases can be centralized or distributed across multiple systems. In other aspects, the object classification system data 707 can be stored on the mass storage device 705 of other servers or devices (e.g., remote computing device 714 a,b,c,) in communication with the object classification system computer 701.

In another aspect, the user can enter commands and information into the object classification system computer 701 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 703 via a human machine interface 702 that is coupled to the system bus 713 but can be connected by other interface and bus structures, such as a parallel port, game port, an IEEE 1394 Port (also known as a Firewire port), a serial port, or a universal serial bus (USB).

In yet another aspect, a display device 711 can also be connected to the system bus 713 via an interface, such as a display adapter 709. It is contemplated that the object classification system computer 701 can have more than one display adapter 709 and more than one display device 711. For example, a display device can be a monitor, an LCD (Liquid Crystal Display), or a projector. In addition to the display device 711, other output peripheral devices can comprise components such as speakers (not shown) and a printer (not shown) which can be connected to the computer 701 via Input/Output Interface 710. Any step and/or result of the methods can be output in any form to an output device. Such output can be any form of visual representation, including, but not limited to, textual, graphical, animation, audio, tactile, and the like.

The object classification system computer 701 can operate in a networked environment using logical connections to one or more remote computing devices 714 a, b, c. By way of example, a remote computing device can be a personal computer, a laptop computer, portable computer, a server, a router, a network computer, a peer device or other common network node, and so on. Logical connections between the object classification system computer 701 and a remote computing device 714 a, b, c can be made via a local area network (LAN) and a general wide area network (WAN). Such network connections can be through a network adapter 708. A network adapter 708 can be implemented in both wired and wireless environments. Such networking environments are conventional and commonplace in offices, enterprise-wide computer networks, intranets, and a network 715 such as the internet 715.

For purposes of illustration, application programs and other executable program components such as the operating system 705 are illustrated herein as discrete blocks, although it is recognized that such programs and components reside at various times in different storage components of the object classification system computer 701 and are executed by the data processor(s) of the computer. An implementation of object classification system software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

According to an embodiment, object classification system computer 701 is configured to execute any method illustrated in the application.

According to an embodiment the object classification system computer 701 is in communication with one or more sensors of one or more types that are associated with the vehicle.

According to an embodiment the object classification system computer 701 is in communication with other vehicle computes such as control computers that are configured to control one or more vehicle units such as an engine controlling computer, a powertrain controlling computer, and/or with an autonomous driving unit configured to control autonomous driving, an ADAS unit configured to control ADAS operations, a path unit configured to navigate the vehicle, and the like. Each unit includes a processing circuit and/or stores in a non-transitory computer readable medium software and/or firmware and/or code and/or instructions for fulfilling the role of the unit.

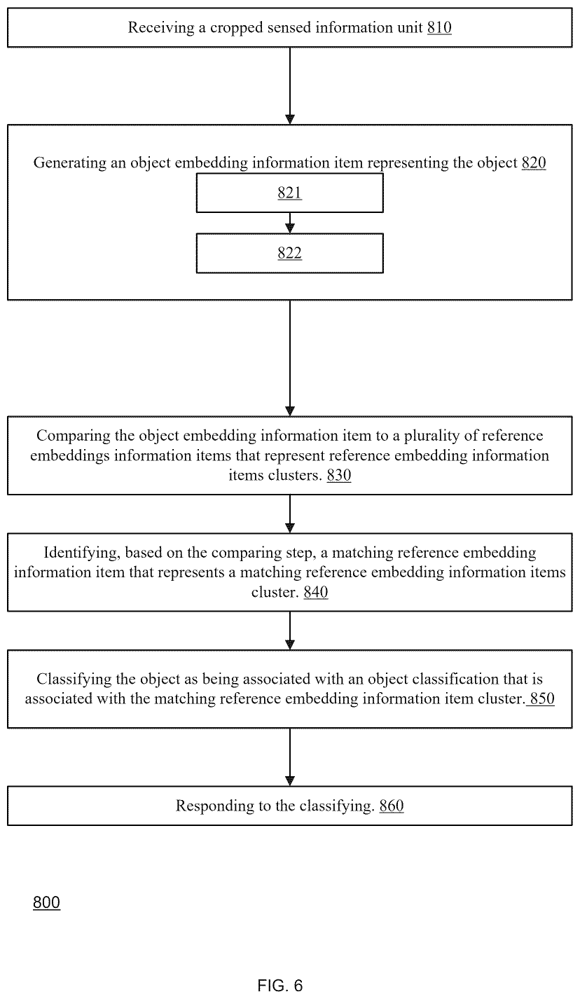

FIG. 6 illustrates an example of method 800.

According to an embodiment method 800 is for object classification.

According to an embodiment, method 800 includes step 810 of receiving, by a processing circuit, a cropped sensed information unit that includes information indicative of an object located within an environment of a vehicle.

According to an embodiment, step 810 is followed by step 820 of generating, by the processing circuit, an object embedding information item representing the object.

An embedding information item may be an embedding or a representation (for example signature) of the embedding.

According to an embodiment, step 820 is followed by step 830 of comparing the object embedding information item to a plurality of reference embeddings information items that represent reference embedding information items clusters.

According to an embodiment, step 830 is followed by step 840 of identifying, based on the comparing step, a matching reference embedding information item that represents a matching reference embedding information items cluster.

According to an embodiment, step 840 is followed by step 850 of classifying the object as being associated with an object classification that is associated with the matching reference embedding information item cluster.

According to an embodiment, step 850 is followed by step 860 of responding to the classifying.

According to an embodiment, step 860 may include at least one of:
a. Triggering a determination of a driving related operation to be executed by the vehicle. The driving related operation may be a fully autonomous operation such as maintaining a current progress of a vehicle, changing a progress of the vehicle, whereas a progress refers to at least one of direction of propagation, speed of propagation and acceleration of the vehicle. Alternatively-the driving related operation is an ADAS operation such as suggesting a driving scheme operation of performing a more limited driving related operation (limited in the sense of its duration).
b. Executing a driving related operation.
c. Determining the navigation path of the vehicle.
d. Populating a database with an outcome of the vehicle.
e. Sending to one or more artificial intelligence agents information regarding the classification.
f. Activating one or more artificial intelligence agents based on the classification.
g. Further processing an initial (pre-cropping) sensed information unit. The cropped information unit was generated by cropping an initial (pre-cropping) information sensing unit.

According to an embodiment, the object embedding information item is an object embedding signature. The reference embeddings information items are reference embeddings signatures. The reference embedding information items clusters are reference embedding signatures clusters.

According to an embodiment, a signature of an embedding is of a higher dimension (also referred to a higher dimensionality or having more dimensions) than the embedding. The increase of the dimensionality may increase the robustness of the detection as higher dimensionality increases the distance between adjacent signatures—in comparison to the distance between corresponding adjacent embeddings. The higher dimension may include having at least 2, 5, 10, 20, 50, 80, 100 dimensions and even more.

A non-limiting example of generating a signature is illustrated in US patent application 2022/0041184 which is incorporated herein by reference.

According to an embodiment, step 820 includes step 821 of generating an object embedding and step 822 of generating the signature of the object embedding, wherein the object embedding has less dimensions than the object embedding signature.

FIG. 7 illustrates an example of an initial sensed information unit such as an image 901 including a bounding box 902 that is indicative of a location of object 903, a cropped image 904 that mostly includes the pixels of the object 903, an object embedding 910 of the cropped image, a signature 912 of the object embedding, reference embedding signatures clusters 920(1)-920(W) that are represented by reference embedding signatures 921(1)-921(X) (that may or may not be included in the reference embedding signature clusters), wherein there may be more than one reference embedding signature per reference embedding signature cluster, other reference embedding signatures 922(1)-922(Y) included in the reference embedding signatures clusters (and differ from the reference embedding signatures 921(1)-921(X)), outliers 925(1)-925(Z) located outside the clusters, reference embedding signatures clusters metadata (923(1)-923(W)) that provide information such as object classification about the clusters, and a matching reference embedding signatures cluster 920(w) that is represented by reference embedding signature 921(w) and is associated with metadata 923(w) indicative of an object classification.

According to an embodiment, the object embedding information item is an object embedding, the reference embeddings information items are reference embeddings, and the reference embedding information items clusters are reference embedding clusters.

According to an embodiment the cropped sensed information unit consists essentially of the information indicative of the object. The cropping increases the accuracy of the object embedding as irrelevant information is mostly removed from the cropped sensed information unit.

According to an embodiment, the cropped sensed information unit was generated based on an initial sensed information unit and a bounding box indicative of the object within the initial sensed information unit.

According to an embodiment, the cropped sensed information was generated based on an initial sensed information unit and a plurality of keypoints within the initial sensed information unit that are associated with the object. Keypoints may be found in any known manner. According to an embodiment, a keypoint is found in the manner illustrated in U.S. Pat. No. 11,037,015 which is incorporated herein by reference.

According to an embodiment, cropped sensed information was generated based on an initial sensed information unit and an initial sensed information unit region that includes a plurality of keypoints within the initial sensed information unit that are associated with the object.

Assuming, that the transformation module (especially an embedding generator within the transformation module) is configured to process content of a given shape—for example it is configured to process a cropped sensed information unit that includes relevant information within a rectangular region of a sensed information unit—then the method includes defining a rectangular region to include the plurality of keypoints (the rectangular region may be defined to be as small as possible—or to include up a limited amount of information outside a smallest region that includes the keypoints)—and to process the content of the rectangular region. The processing may include aligning the rectangular region (which may be oriented to the horizon) before providing the rectangular box to the embedding generator.

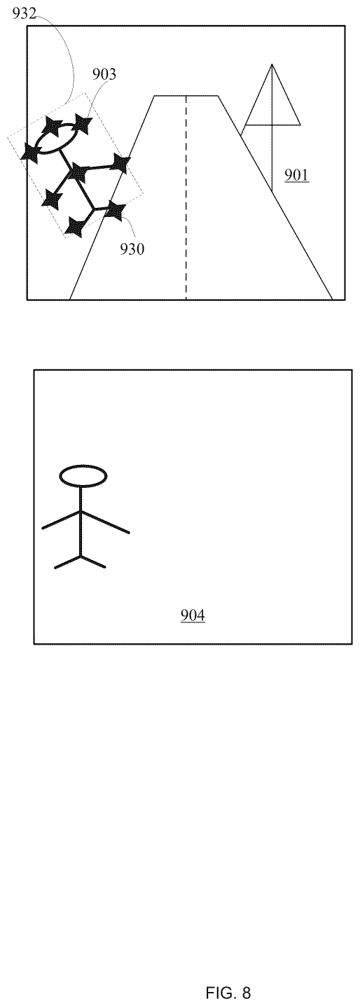

FIG. 8 illustrates a sensed information unit such as image 950, including object 903, including keypoints 930 of the object, a bounding box 932 that surrounds the keypoints 930, and a cropped image 904. The bounding box 932 is oriented and the cropped image includes an aligned bounding box 933.

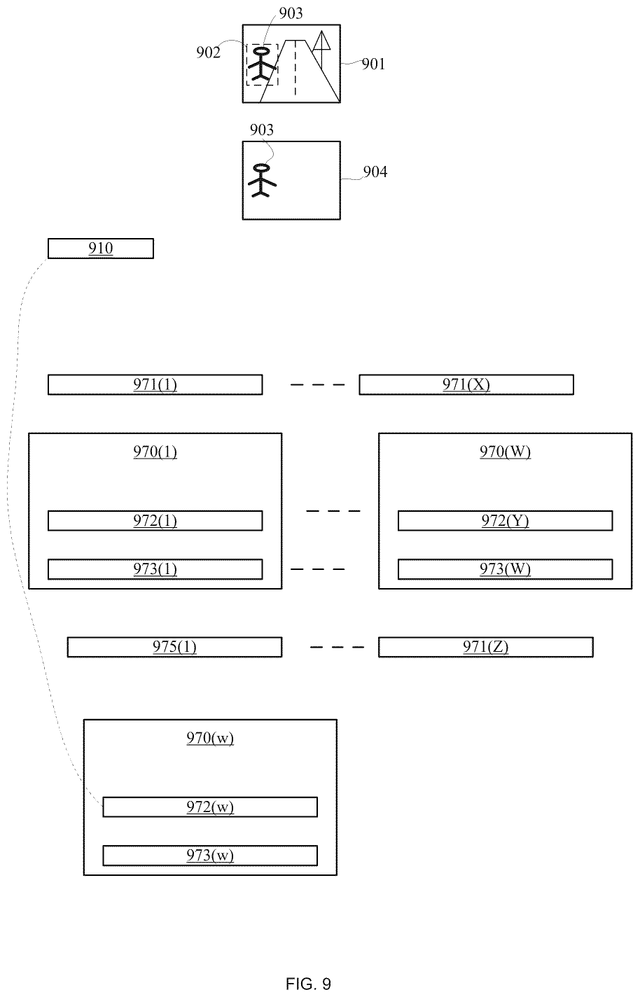

FIG. 9 illustrates an example of an initial sensed information unit such as an image 901 including a bounding box 902 that is indicative of a location of object 903, a cropped image 904 that mostly includes the pixels of the object 903, an object embedding 910 of the cropped image, reference embedding clusters 970(1)-970(W) that are represented by reference embedding 971(1)-971(X), wherein there may be more than one reference embedding per reference embedding cluster, other reference embedding 972(1)-972(Y) included in the reference embedding clusters (and differ from the reference embedding 971(1)-971(X)), outliers 975(1)-975(Z) located outside the clusters, reference embedding clusters metadata (973(1)-973(W)) that provide information such as object classification about the clusters, and a matching reference embedding cluster 970(w) that is represented by reference embedding 971(w).

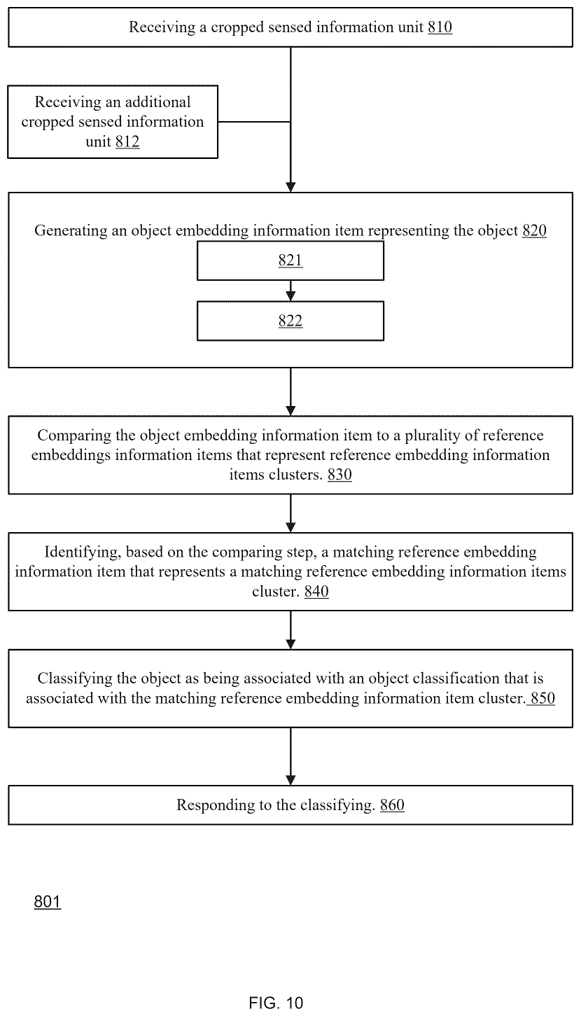

FIG. 10 illustrates an example of method 801.

According to an embodiment method 80′ is for object classification.

According to an embodiment, method 80′ includes step 810 of receiving, by a

processing circuit, a cropped sensed information unit that includes information indicative of an object located within the environment of a vehicle.

According to an embodiment, method 810 also includes step 812 of receiving, by the processing circuit, an additional cropped sensed information unit that includes additional information indicative of the object located within the vehicle environment. While the cropped sensed information unit received in step 810 was sensed by a sensor of a first type, the additional cropped sensed information unit was sensed by a sensor of second type differs from the first type. The types of sensors may differ from each other by radiation frequency (for example radar versus visible light), resolution, point of view (for example aerial point of view or ground level point of view), active sensor versus passive sensor, and the like. Examples of sensors of different types include a visual light camera, an audio sensor, a sensor that may sense infrared, radar imagery, ultrasound, electro-optics, radiography, LIDAR (light detection and ranging), and the like.

According to an embodiment, step 810 and step 812 are followed by step 820 of generating, by the processing circuit, an object embedding information item representing the object.

According to an embodiment, step 820 is followed by step 830 of comparing the object embedding information item to a plurality of reference embeddings information items that represent reference embedding information items clusters.

According to an embodiment, step 830 is followed by step 840 of identifying, based on the comparing step, a matching reference embedding information item that represents a matching reference embedding information items cluster.

According to an embodiment, step 840 is followed by step 850 of classifying the object as being associated with an object classification that is associated with the matching reference embedding information item cluster.

According to an embodiment, step 850 is followed by step 860 of responding to the classifying.

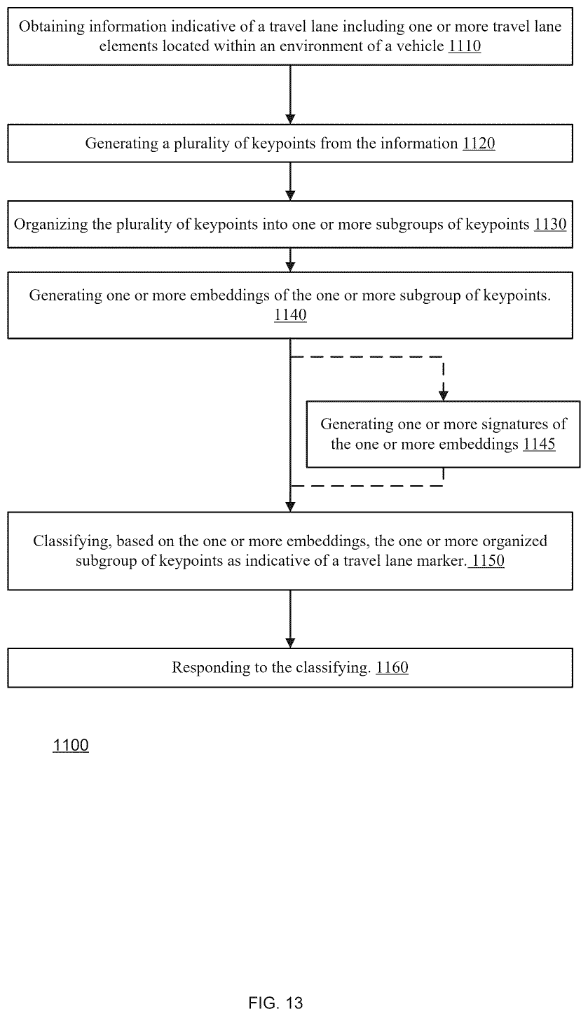

FIG. 13 illustrates an example of an initial sensed information unit such as an image 901 including a bounding box 902 that is indicative of a location of object 903, a cropped image 904 that mostly includes the pixels of the object 903, an additional initial sensed information unit such as an additional image 901-1 including a bounding box 902-1 that is indicative of a location of object 903, an additional cropped image 904-4 that mostly includes the pixels of the object 903. The additional image is acquired by a sensor of a different type than the sensor that sensed image 901.

FIG. 14 illustrates an example of a system 101 that includes a first neural network 1000-1 configured to receive a sensed information unit such as image 1010-1 and perform an object detection to provide an first output image 1010-2 with first bounding box 1010-3 and second bounding box 1010-4 corresponding to first object 1010-5 and second object 1010-6, the first output image 1010-2 is sent to an crop unit 1000-2 configured to generate first cropped image 1010-7 and second cropped 1010-8—associated with the first and second objects, respectively. The first and second cropped images are fed to embedding unit 1000-3 that generates a first object embedding 1010-11 and a second object embedding 1010-12.

A matching unit 1000-4 identifies, for each one of the first object embedding and a second object embedding a matching reference embedding—first matching reference embedding 1012-1 and second matching reference embedding 1012-2. If there is no match for any one of the object embeddings, then that object embedding is regarded to be being classified into an insufficient confidence level.

Assuming a first object related match—the first matching reference embedding 1012-1 represents a first reference embedding cluster 1013-1 associated with a first object classification 1014-1—and the first object is classified as belonging to the first object classification 1014-1.

Assuming a second object related match—the second matching reference embedding 1012-2 represents a second reference embedding cluster 1013-2 associated with a second object classification 1014-2—and the second object is classified as belonging to the second object classification 1014-2.

According to an embodiment, the matching and the clustering are not executed in the embedding domain but at the embedding signature domain. Accordingly—there is an embedding signature generator 1000-34 between the embedding unit 1000-3 and the matching unit 1004. In this case the matching unit 1000-4 identifies, for each object embedding signature a matching reference embedding signature that represents a reference embedding signature cluster associated with an object classification 1014-1.

It should be noted that the clusters are managed (re-evaluated, reduced, re-defined) by a cluster manager 1000-9.

According to an embodiment, the object detection applied by the first neural network 1000-1 includes estimating a presence of an object within the sensed information unit. In addition to the bounding box, the first neural network also outputs its estimation of the object associated with the bounding box. This estimate is referred to as an initial object estimate. For example-first bounding box 1010-3 is associated with first object 1010-5 that is initially estimated to be a pedestrian.

According to an embodiment, system 101 generates first cropped image 1010-7 that includes the first object, generates a first object embedding 1010-11, finds a first matching reference embedding 1012-1 that represents a first reference embedding cluster 1013-1 associated with a first object classification 1014-1-classifies the first object as belonging to the first object classification 1014-1.

According to an embodiment, when there is a mismatch between the first object classification 1014-1 and the initial estimate of the initial object estimate—system 101 determines that at least one of the initial object estimate or the first object embedding is faulty.

According to an embodiment, a mismatch occurs when the initial object estimate and the first object classification contradict each other—for example, the initial object estimate is of a pedestrian and the first object classification is of a vehicle.

According to an embodiment, the difference between the initial object estimate and the first object classification is not regarded as a mismatch. Such a difference may be attributed to the higher accuracy of the matching process—which may provide more details about the first object. For example—the initial object estimate may be coarser than the first object classification (may have coarser or broader classes than the finer classes used to determine the initial object estimate).

For example, the initial object estimate may provide an estimate of a type of an object (for example a vehicle) and the first object classification may determine a sub-type of the object (for example a minivan, a SUV, a station wagon, a vehicle manufactured by a certain manufacturer, a model of the vehicle).

According to an embodiment, when there is a mismatch, the system estimates that the initial object estimate is faulty—as the matching process is regarded to be more reliable than the initial object estimate.

According to an embodiment, the system is configured to respond to the mismatch.

According to an embodiment, the response includes at least one of: providing an indication of a first neural network error, requesting or suggesting to train the first neural network, requesting or suggesting or instructing to evaluate the embedding process, requesting or suggesting or instructing to evaluate the matching process, requesting or suggesting or instructing to evaluate the cropping process, requesting or suggesting or instructing to use a FP removal module (such as FP removal module 110 of FIG. 1) to perform a FP removal operation, requesting or suggesting or instructing to perform a cluster management operation such as re-clustering or deleting a cluster or adding a cluster or changing one or more clustering parameter such as a distance between cluster members, a distance between members of different clusters, and the like.

System of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for object classification. The method also includes receiving, by a processing circuit, a sensed information unit that includes information indicative of an object located within a vehicle environment. The method also includes dynamically generating, by the processing circuit, an embedding of the object, where the embedding is a discriminating feature vector representing the object. The method also includes comparing the embedding to a plurality of reference embedding clusters, where each of the plurality of reference embedding clusters is associated with an object classification of a plurality of reference objects. The method also includes classifying, based on the comparing step, the embedding as being associated with one of the plurality of reference embedding clusters. Other embodiments of this aspect include corresponding computer systems, apparatus, and computer programs recorded on one or more computer storage devices, each configured to perform the actions of the methods.

Implementations of the method for object classification may include one or more of the following features. The method may include limiting the dynamic range of the sensed information unit. The sensed information unit may include a cropped sensed information unit cropped from a sensed information unit received from a sensing unit of the vehicle. The supervised machine learning training may include applying a cost function that induces generation of similar reference embeddings to similar objects and dissimilar reference embeddings to dissimilar objects. The classifying step initiates further processing of the sensed information unit. The plurality of reference embedding clusters represents a larger group of reference embeddings, where the larger group of reference embeddings is generated during a supervised machine learning training may include feeding cropped images to a bounding shape generating neural network. The method may include dynamically updating the plurality of reference embedding clusters. The plurality of reference embedding clusters is generated by clustering one or more subgroups of reference embeddings of a larger group of reference embeddings into a plurality of clusters.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for travel lane feature classification. The method also includes obtaining, via a processing circuit, information indicative of a travel lane including one or more travel lane features located within a vehicle environment. The method also includes generating a plurality of keypoints from the information. The method also includes organizing the plurality of keypoints into one or more subgroups of keypoints, where each of the one or more subgroups of keypoints is indicative of one or more categories of travel lane features. The method also includes classifying, based on the organizing step, the one or more organized subgroups of keypoints as indicative of a travel lane marker. Other embodiments of this aspect include corresponding computer systems, apparatus, and computer programs recorded on one or more computer storage devices, each configured to perform the actions of the methods.

Implementations of the method for travel lane feature classification may include one or more of the following features. The obtaining step may include obtaining, by an imaging sensor, a field of view image of a viewable area including the environment of the vehicle. The organizing step may include clustering each of the one or more subgroups of keypoints according to one or more pre-determined aspect ratios. The method may include cropping the clustered one or more subgroups of keypoints by: determining minimum shape dimensions of a shape bounding the clustered one or more subgroups of keypoints; and adding a lateral margin and vertical margin to the minimum shape dimensions. The method may include rotating the cropped clustered one or more subgroups of keypoints to an upright position. The method may include resizing the upright cropped clustered one or more subgroups of keypoints to a fixed size. The organizing step may include clustering the one or more subgroups of keypoints based on aspect ratios. The organizing step may include training a classifier to classify each of the one or more subgroups of keypoints based on the aspect ratios. The method may include classifying, based on the organizing step, at least a second subgroup of keypoints as indicative of a road boundary. The method may include classifying, based on the organizing step, at least a third subgroup of keypoints as indicative of an incidental marking. Implementations of the described techniques may include hardware, a method or process, or computer software on a computer-accessible medium.

FIG. 15 illustrates an example of a method 1100 for travel lane element classification.

According to an embodiment, method 1100 includes step 1110 of obtaining, via a processing circuit, information indicative of a travel lane including one or more travel lane elements located within the environment of a vehicle.

According to an embodiment, step 1110 is followed by step 1120 of generating a plurality of keypoints from the information.

According to an embodiment, step 1120 is followed by step 1130 of organizing the plurality of keypoints into one or more subgroups of keypoints, wherein each of the one or more subgroup of keypoints is indicative of one or more categories of travel lane elements.

According to an embodiment, step 1130 is followed by step 1140 of generating one or more embeddings of the one or more subgroup of keypoints.

According to an embodiment, step 1140 is followed by step 1150 of classifying, based on the one or more embeddings, the one or more organized subgroup of keypoints as indicative of a travel lane marker.

According to an embodiment, step 1150 is followed by step 1160 of responding to the classifying.

According to an embodiment, step 1160 may include at least one of:
a. Triggering a determination of a driving related operation to be executed by the vehicle. The driving related operation may be a fully autonomous operation such as maintaining a current progress of a vehicle, changing a progress of the vehicle, whereas a progress refers to at least one of direction of propagation, speed of propagation and acceleration of the vehicle. Alternatively-the driving related operation is an ADAS operation such as suggesting a driving scheme operation of performing a more limited driving related operation (limited in the sense of its duration).
b. Executing a driving related operation.
c. Determining the navigation path of the vehicle.
d. Populating a database with an outcome of the vehicle.
e. Sending to one or more artificial intelligence agents information regarding the classification.
f. Activating one or more artificial intelligence agents based on the classification.
g. Further processing an initial (pre-cropping) sensed information unit. The cropped information unit was generated by cropping an initial (pre-cropping) information sensing unit.

According to an embodiment, method 1100 includes step 1145 of generating one or more signatures of the one or more embeddings, the one or more signatures are of higher dimensionality that the one or more embeddings, wherein the classifying is based on the one or more signatures.

Step 1150 of classifying the one or more organized subgroup of keypoints as indicative of a travel lane marker will be based on the signatures of the one or more embeddings.

According to an embodiment, the information indicative of the travel lane is a sensed information unit, and step 1140 may include or may be preceded by generating one or more cropped sensed information units, one cropped information unit per subgroup of keypoints. The one or more embeddings are generated based on the one or more cropped sensed information unit.

Any combination of any step of any method illustrated in the application is provided.

According to an embodiment there is provided a method that includes receiving, by a processing circuit, a sensed information unit that includes information indicative of an object located within a vehicle environment; dynamically generating, by the processing circuit, an embedding of the object, wherein the embedding is a discriminating feature vector representing the object; comparing the embedding to a plurality of reference embedding clusters, wherein each of the plurality of reference embedding clusters is associated with an object classification of a plurality of reference objects; and classifying, based on the comparing step, the embedding as being associated with one of the plurality of reference embedding clusters.

According to an embodiment the method further includes limiting the dynamic range of the sensed information unit.

According to an embodiment, the sensed information unit is a cropped sensed information unit.

According to an embodiment, the classifying step initiates further processing of the sensed information unit.

According to an embodiment, the plurality of reference embedding clusters represents a larger group of reference embeddings, wherein the larger group of reference embeddings is generated during a supervised machine learning training comprising feeding cropped images to a bounding shape generating neural network.

According to an embodiment, the supervised machine learning training comprises applying a cost function that induces generation of similar reference embeddings to similar objects and dissimilar reference embeddings to dissimilar objects.

According to an embodiment, the method includes dynamically updating the plurality of reference embedding clusters.

According to an embodiment, the plurality of reference embedding clusters is generated by clustering one or more subgroups of reference embeddings of a larger group of reference embeddings into a plurality of clusters.

According to an embodiment there is provided a non-transitory computer readable medium for object classification, the non-transitory computer readable medium stores instructions that once executed by an object classification system of the vehicle cause the object classification system to: receive a sensed information unit that includes information indicative of an object located within a vehicle environment; dynamically generate an embedding of the object, wherein the embedding is a discriminating feature vector representing the object; compare the embedding to a plurality of reference embedding clusters, wherein each of the plurality of reference embedding clusters is associated with an object classification of a plurality of reference objects; and classify, based on the comparing step, the embedding as being associated with one of the plurality of reference embedding clusters.

According to an embodiment, the object classification system is further configured to limit the dynamic range of the sensed information unit.

According to an embodiment, the sensed information unit is a cropped sensed information unit.

According to an embodiment, the classifying step initiates further processing of the sensed information unit.

According to an embodiment, the plurality of reference embedding clusters represents a larger group of reference embeddings, wherein the larger group of reference embeddings is generated during a supervised machine learning training comprising feeding cropped images to a bounding shape generating neural network.

According to an embodiment, the supervised machine learning training comprises applying a cost function that induces generation of similar reference embeddings to similar objects and dissimilar reference embeddings to dissimilar objects.

According to an embodiment, the object classification system is further configured to dynamically update the plurality of reference embedding clusters.

According to an embodiment, the plurality of reference embedding clusters is generated by clustering one or more subgroups of reference embeddings of a larger group of reference embeddings into a plurality of clusters.

According to an embodiment there is provided an object classification system of a vehicle, the object classification system comprising: one or more processing circuits that comprise at least a part of an integrated circuit, the one or more processing circuits are configured to: receive a sensed information unit that includes information indicative of an object located within a vehicle environment; dynamically generate an embedding of the object, wherein the embedding is a discriminating feature vector representing the object; compare the embedding to a plurality of reference embedding clusters, wherein each of the plurality of reference embedding clusters is associated with an object classification of a plurality of reference objects; and classify, based on the comparing step, the embedding as being associated with one of the plurality of reference embedding clusters.

According to an embodiment, the plurality of reference embedding clusters represents a larger group of reference embeddings, wherein the larger group of reference embeddings is generated during a supervised machine learning training comprising feeding cropped images to a bounding shape generating neural network.

According to an embodiment, the supervised machine learning training comprises applying a cost function that induces generation of similar reference embeddings to similar objects and dissimilar reference embeddings to dissimilar objects.

According to an embodiment, the sensed information unit is a cropped sensed information unit.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle-such as a ground transportation vehicle, an airborne vehicle, or a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a spanning element. A spanning element may be implemented in software or hardware. Different spanning element of a certain iteration are configured to apply different mathematical functions on the input they receive. Non-limiting examples of the mathematical functions include filtering, although other functions may be applied.

The specification and/or drawings may refer to a concept structure. A concept structure may include one or more clusters. Each cluster may include signatures and related metadata. Each reference to one or more clusters may be applicable to a reference to a concept structure.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly-any reference to object detection is applicable mutatis mutandis to a pattern detection.

A situation may be a singular location/combination of properties at a point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system—or may belong to different devices of systems.

A perception unit may be provided and may be preceded by the one or more sensors and/or by one or more interfaces from receiving one or more sensed information units. The perception unit may be configured to receive a sensed information unit from an I/O interface and/or from a sensor. The perception unit may be followed by multiple narrow AI agents-also referred to as an ensemble of narrow AI agents.

A sensed information unit may or may not be processed before reaching the perception unit. Any processing may be providing-filtering, noise reduction, and the like.

We claim:

1. A method that is computer implemented for downstream processing of embedding information items, the method comprises:
receiving multiple evaluated element embedding information items that represent multiple evaluated elements within an environment of a vehicle;
identifying that the multiple evaluated element embedding information items are classified into an insufficient confidence level; and
for each one of the multiple evaluated embedding information items identified being classified into an insufficient confidence level, automatically routing evaluated element information to a corresponding embedding information item-based classification unit that is trained to classify elements represented by the evaluated element embedding information item associated with a corresponding population of embedding information items.

2. The method according to claim 1, wherein the identifying step comprises comparing the multiple element embedding information items to a plurality of reference embeddings information items that represent a plurality of reference embedding information items clusters.

3. The method according to claim 1, further comprising classifying the evaluated element, by the corresponding embedding information item-based classification unit, wherein the classifying triggers a determination of a driving related operation for a vehicle.

4. The method according to claim 1, wherein the evaluated element information is a sensed information unit.

5. The method according to claim 1, wherein the evaluated element information is a cropped sensed information unit.

6. The method according to claim 1, wherein the first embedding item-based classification unit is trained across a population of embedding that is larger than each corresponding population of embeddings.

7. The method according to claim 1, wherein the evaluated element embedding information item is an evaluated element embedding signature.

8. The method according to claim 1, wherein the evaluated element embedding information item is an evaluated element embedding.

9. The method according to claim 1, wherein the identifying triggers a generation of a routing rule for bypassing the step of comparing when receiving future evaluated element embedding information items having a same value as the evaluated element embedding information item.

10. The method according to claim 1, wherein the identifying triggers a re-evaluation of the plurality of reference embeddings information items.

11. The method according to claim 1, wherein the routing comprises selecting each corresponding embedding information item-based classification unit out of a plurality of embedding information item-based classification units.

12. A non-transitory computer readable medium for downstream processing of embedding information items, the non-transitory computer readable medium stores instructions that once executed by a computerized system cause the object computerized system to:
receive multiple evaluated element embedding information items that represent multiple evaluated elements within an environment of a vehicle;
identify that the multiple evaluated element embedding information items are classified into an insufficient confidence level; and
for each one of the multiple evaluated embedding information items identified as being classified into an insufficient confidence level, automatically route evaluated element information to a corresponding embedding information item-based classification unit that is trained to classify elements represented by the evaluated element embedding information item associated with the corresponding population of embedding information items.

13. The non-transitory computer readable medium according to claim 12, wherein the identifying step comprises comparing the multiple element embedding information items to a plurality of reference embeddings information items that represent a plurality of reference embedding information items clusters.

14. The non-transitory computer readable medium according to claim 12, further storing instructions for classifying the evaluated element, by the corresponding embedding information item-based classification unit, wherein the classifying triggers a determination of a driving related operation for a vehicle.

15. The non-transitory computer readable medium according to claim 12, wherein the evaluated element information is a sensed information unit.

16. The non-transitory computer readable medium according to claim 12, wherein the evaluated element information is a cropped sensed information unit.

17. The non-transitory computer readable medium according to claim 12, wherein the first embedding item-based classification unit is trained across a population of embedding that is larger than each corresponding population of embeddings.

18. The non-transitory computer readable medium according to claim 12, wherein the identifying triggers a generation of a routing rule for bypassing the step of comparing when receiving future evaluated element embedding information items having a same value as the evaluated element embedding information item.

19. The non-transitory computer readable medium according to claim 12, wherein the identifying triggers a re-evaluation of the plurality of reference embeddings information items.

20. A computerized system for downstream processing of embedding information items, the computerized system comprises:
a memory unit that is configured to store multiple evaluated elements embedding information items that represents multiple evaluated elements within an environment of a vehicle; and
a processing circuit that is configured to identify that the multiple evaluated element embedding information items are classified into an insufficient confidence level; and
for each one of the multiple evaluated embedding information items identified as being classified into the insufficient confidence level, automatically routing the evaluated element embedding information item to a corresponding embedding information item-based classification unit that is trained to classify elements represented by the evaluated element embedding information item associated with the corresponding population of embedding information items.
